(19) United States
(12) Patent Application Publication
(10) Pub. No.: US 2026/0328380 A1
(43) Pub. Date: Oct. 22, 2026

(54) LED LAMP

(71) Applicant: SHENZHEN SNC OPTO ELECTRONIC CO., LTD., Shenzhen (CN)

(72) Inventors: Jianyong Xu, Shenzhen (CN); Shize Wei, Shenzhen (CN); Liang Wang, Shenzhen (CN)

(21) Appl. No.: 19/253,965

(22) Filed: Jun. 30, 2025

(30) Foreign Application Priority Data
Apr. 17, 2025 (CN) 202510481068.4

(51) Int. Cl. F21V 23/04; F21V 5/00; F21Y 115/10

(52) U.S. Cl. CPC F21V 23/0442; F21V 5/007; F21Y 2115/10

(57) ABSTRACT

An LED lamp includes a housing including a base and a cover being provided with a mounting groove, the cover including a first mounting surface and a second mounting surface that intersecting each other and provided in the mounting groove; a first LED lamp panel provided on the first mounting surface; a second LED lamp panel provided on the second mounting surface; a control device; and a lens plate covering on the first LED lamp panel and the second LED lamp panel. The first LED lamp panel includes a first light emitting element, the second LED lamp panel includes a second light emitting element, and the control device is configured to switch the first light emitting element and the second light emitting element to emit light according to different positions of the lens plate.

### CROSS-REFERENCE TO RELATED APPLICATIONS

This application claims priority to Chinese Patent Application No. 202510481068.4, filed on Apr. 17, 2025, entitled “LED LAMP”, the entire content of which is incorporated herein by reference in its entirety.

### TECHNICAL FIELD

The present disclosure relates to the field of lighting devices, and in particular to an LED lamp.

### BACKGROUND

LED lamps use LEDs as light sources, which have the advantages of energy saving, environmental protection and long service life, and have widely replaced lighting lamps with conventional light sources. When the LED lamp is mounted on a wall, corridors, courtyard paths and other sites can be illuminated or decorated. The lighting area of the existing LED lamp is generally fixed and cannot be adjusted according to the lighting site. In addition, the position of a lens plate of the existing LED lamp is fixed, and the position of the lens plate cannot be flexibly adjusted according to the requirements of different usage sites, thus the light distribution direction of the LED lamp cannot be adjusted.

### SUMMARY

Accordingly, it is necessary to provide an LED lamp that not only has the lighting effects of full light cutoff and half light cutoff, but also can flexibly switch a light emitting angle of the LED lamp.

An LED lamp includes: a housing including a base and a cover covering the base, the cover being provided with a mounting groove, the cover including a first mounting surface and a second mounting surface that intersecting each other and provided in the mounting groove; a first LED lamp panel provided on the first mounting surface; a second LED lamp panel provided on the second mounting surface; a driving power supply configured to supply power to the first LED lamp panel and the second LED lamp panel; a control device electrically connected to the first LED lamp panel, the second LED lamp panel, and the driving power supply; and a lens plate covering the first LED lamp panel and the second LED lamp panel in a light emitting direction. The first LED lamp panel includes a first circuit board and a first light emitting element; the second LED lamp panel includes a second circuit board and a second light emitting element, and the control device is configured to switch the first light emitting element and the second light emitting element to emit light according to different positions of the lens plate.

In an embodiment, the lens plate is provided with a light diffusion rib, the lens plate includes a first lens plate, a second lens plate, a third lens plate, and a fourth lens plate; the first lens plate is connected to the second lens plate, a plurality of diamond-shaped lens portions are provided between the first lens plate and the second lens plate on a side away from the first light emitting element and the second light emitting element, and the third lens plate and the fourth lens plate are provided in parallel at both ends of the first lens plate and the second lens plate.

In an embodiment, the first lens plate, the second lens plate, the third lens plate, and the fourth lens plate are integrally formed and are each in a straight plane shape.

In an embodiment, the first lens plate, the second lens plate, the third lens plate, and the fourth lens plate are provided with a plurality of strip-shaped grooves on a side adjacent to the first light emitting element and the second light emitting element.

In an embodiment, the first light emitting element includes a first lamp bead and a second lamp bead, and the second light emitting element includes a third lamp bead and a fourth lamp bead.

In an embodiment, the control device includes an angle controller, the angle controller includes a switch base, a first electronic switch, and a first toggle; the switch base is fixed on the base, the first electronic switch is fixed on the switch base, the first electronic switch is electrically connected to the driving power supply, the first LED lamp panel and the second LED lamp panel respectively, the first electronic switch has a plurality of states, the first toggle is connected to the first electronic switch and is configured to be toggled to change the state of the first electronic switch, and the first electronic switch is configured to control the first lamp bead, the second lamp bead, the third lamp bead and the fourth lamp bead to emit light according to different states.

In an embodiment, when the first electronic switch is in a first state, the first lamp bead emits light;
when the first electronic switch is in a second state, the first lamp bead and the second lamp bead emit light;
when the first electronic switch is in a third state, the second lamp bead emits light;
when the first electronic switch is in a fourth state, the first lamp bead, the second lamp bead, the third lamp bead and the fourth lamp bead emit light;
when the first electronic switch is in a fifth state, the third lamp bead emits light;
when the first electronic switch is in a sixth state, the third lamp bead and the fourth lamp bead emit light; and
when the first electronic switch is in a seventh state, the fourth lamp bead emits light.

In an embodiment, the control device includes a color temperature controller, the color temperature controller includes a second electronic switch and a second toggle, the second electronic switch is fixed on the switch base, the second electronic switch is electrically connected to the driving power supply, the first LED lamp panel, and the second LED lamp panel respectively, the second electronic switch has a plurality of states, the second toggle is connected to the second electronic switch and is configured to be toggled to change the state of the second electronic switch, and the second electronic switch is configured to control a color temperature of the LED lamp accord to different states of the second electronic switch.

In an embodiment, the LED lamp further includes a first sealing ring provided between the lens plate and the cover and a second sealing ring provided between the base and the cover.

In an embodiment, the LED lamp further includes a sensor provided on the base, the sensor is configured to sense external environmental parameters to control on and off of the LED lamp or brightness of the LED lamp.

According to the LED lamp, the first LED lamp panel and/or the second LED lamp panel can be flexibly turned on according to the lighting requirements of the application site, which can well meet the lighting requirements of full light cutoff and half light cutoff. The overall light is very soft without glare, and a good lighting effect can be achieved. In addition, whether the first light emitting element and the second light emitting element on the first LED lamp board and the second LED lamp board emit light can be switched, and the application sites are more extensive.

The details of one or more embodiments of the application are set forth in the accompanying drawings and the description below. Other features, objects, and advantages of the application will be apparent from the description and drawings, and from the claims.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 is a perspective view of an LED lamp according to an embodiment of the present invention.

FIG. 2 is a cross-sectional perspective view of the LED lamp of FIG. 1.

FIG. 3 is an enlarged view of a portion A of FIG. 2.

FIG. 4 is an exploded view of the LED lamp of FIG. 1.

FIG. 5 is an enlarged view of a portion B of FIG. 4.

FIG. 6 is a perspective view of a lens plate in FIG. 4.

FIG. 7 is an exploded view of a control device in FIG. 4.

### REFERENCE NUMERALS

1. Housing. 2. Driving power supply. 3. Base. 4. Cover. 5. Mounting groove. 6. First mounting surface. 7. Second mounting surface. 8. First LED lamp panel. 9. Second LED lamp panel. 10. Control device. 11. Lens plate. 12. First circuit board. 13. First light emitting element. 14. Second circuit board. 15. Second light emitting element. 16. First lamp bead. 17. Second lamp bead. 18. Third lamp bead. 19. Fourth lamp bead. 20. Angle control. 21. Switch base. 22. First electronic switch. 23. First toggle. 24. Light diffusion rib. 25. First lens plate. 26. Second lens plate. 27. Third lens plate. 28. Fourth lens plate. 29. Diamond-shaped lens portion. 30. Strip-shaped groove. 31. Color temperature controller. 32. Second electronic switch. 33. Second toggle. 34. First sealing ring. 35. Second seal ring. 36. Sensor. 37. Plugging member. 38. Cover box.

### DETAILED DESCRIPTION OF THE EMBODIMENTS

The technical solution in the embodiment of the present disclosure will be clearly and completely described below in conjunction with the drawings in the embodiment of the application. Apparently, the described embodiments are only some of the embodiments of the application, not all of them. Based on the embodiments in the present disclosure, all other embodiments obtained by a person skilled in the art without making creative efforts shall all fall within the protection scope of the present disclosure.

In the drawings of the embodiments of the present disclosure, the same or similar numbers correspond to the same or similar components. In the description of the present disclosure, it should be understood that terms “upper”, “lower”, “front” and “rear”, “left”, “right”, “vertical”, “horizontal”, “lateral”, “longitudinal”, “top”, “bottom”, “inner”, “outer”, and other indicated orientation or positional relationships are based on the orientation or positional relationship shown in the drawings for convenience and simplicity of description of the present disclosure only, and not as an indication or implication that the devices or elements referred to must have or be constructed or operated in a specific orientation. Therefore, the terms describing positional relationships in the drawings are only for illustrative purposes and should not be construed as limitations of the present disclosure.

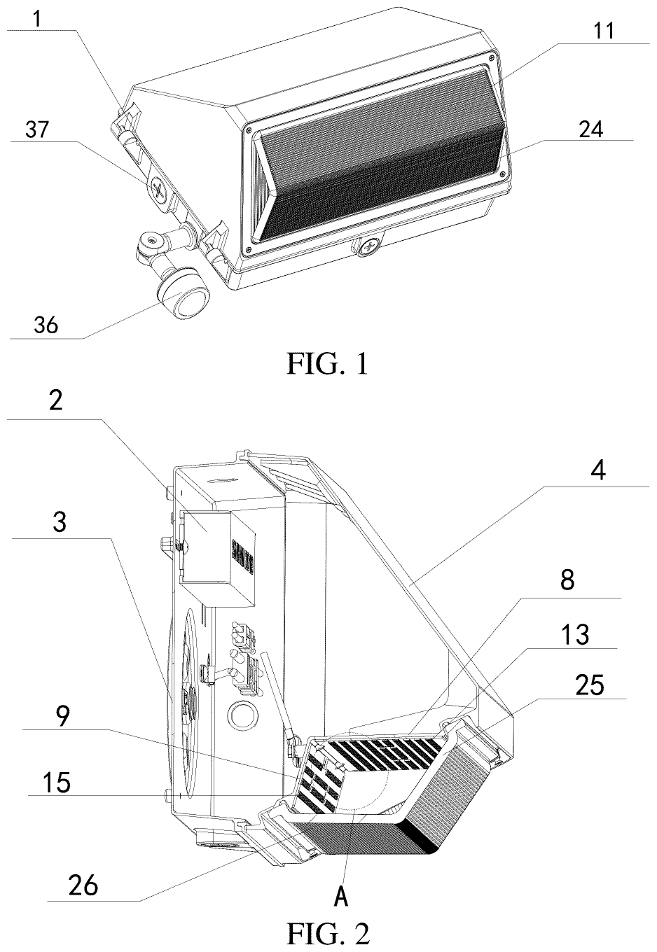

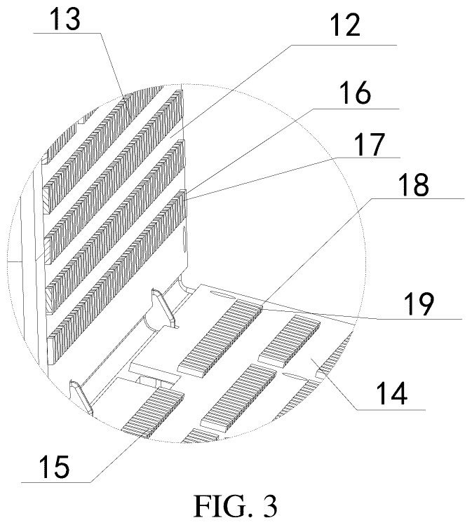

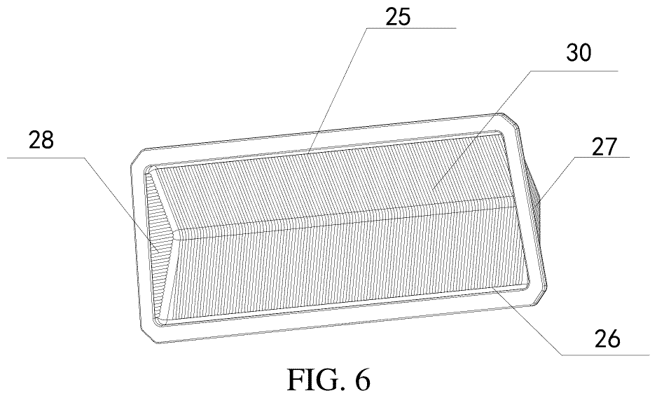

Referring to FIGS. 1 to 7, an LED lamp is provided according to embodiment of the present invention, which includes a housing 1 and a driving power supply 2. The housing 1 includes a base 3 and a cover 4 covering the base 3. The cover 4 is provided with a mounting groove 5. A first mounting surface 6 and a second mounting surface 7 that intersecting each other and provided in the mounting groove 5. A first LED lamp panel 8 is provided on the first mounting surface 6. A second LED lamp panel 9 is provided on the second mounting surface 7. The driving power supply 2 is configured to supply power to the first LED lamp panel 8 and the second LED lamp panel 9. The LED lamp further includes a control device 10 electrically connected to the first LED lamp panel 8, the second LED lamp panel 9 and the driving power supply 2. A lens plate 11 is covered on the first LED lamp panel 8 and the second LED lamp panel 9 in a light emitting direction. The first LED lamp panel 8 includes a first circuit board 12 and a first light emitting element 13. The second LED lamp panel 9 includes a second circuit board 14 and a second light emitting element 15. The control device 10 is configured to switch the first light emitting element 13 and the second light emitting element 15 to emit light according to different positions of the lens plate 11.

The first circuit board 12 has a larger area than the second circuit board 14 and intersects the second circuit board 14.

Since the first mounting surface 6 and the second mounting surface 7 that intersect each other and provided in the mounting groove 5, the light emitting angles of the first LED lamp panel 8 and the second LED lamp panel 9 are different, so that the lighting effects of full light cutoff and half light cutoff can be simultaneously realized according to the requirements of the full light cutoff and half light cutoff.

Referring to FIG. 2 to FIG. 4, the first light emitting element 13 includes a first lamp bead 16 and a second lamp bead 17, and the first lamp bead 16 and the second lamp bead 17 are alternately arranged on the first circuit board 12. The second light emitting element 15 includes a third lamp bead 18 and a fourth lamp bead 19. The third lamp bead 18 and the fourth lamp bead 19 are alternately arranged on the second circuit board 14.

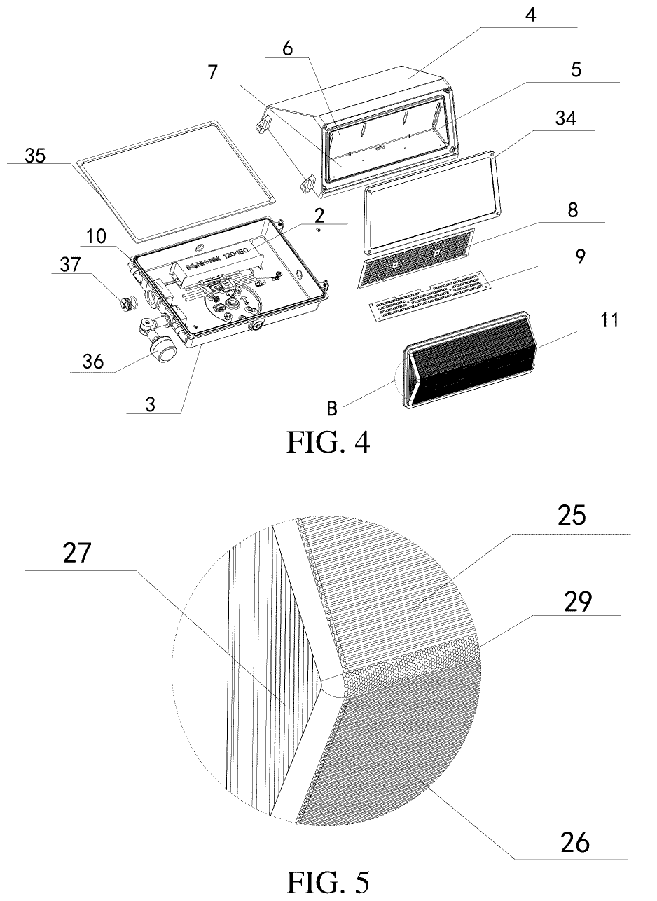

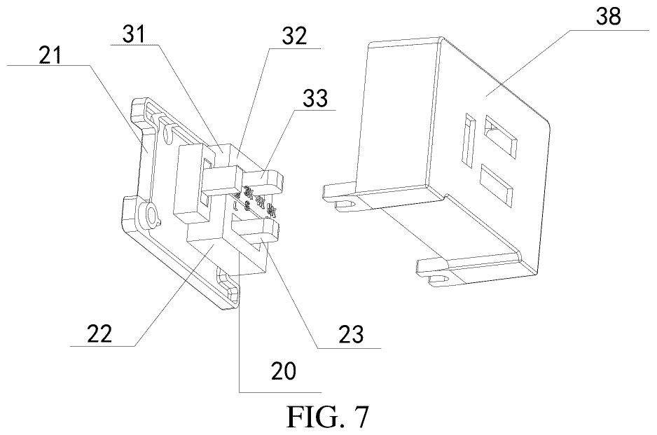

Referring to FIG. 1, FIG. 4 and FIG. 7, the control device 10 includes an angle controller 20. The angle controller 20 includes a switch base 21, a first electronic switch 22, and a first toggle 23. The switch base 21 is fixed on the base 3, and the first electronic switch 22 is fixed on the switch base 21. The first electronic switch 22 is electrically connected to the driving power supply 2, the first LED lamp panel 8, and the second LED lamp panel 9, respectively. The first electronic switch 22 has a plurality of states. The first toggle 23 is connected to the first electronic switch 22 and is configured to be toggled to change the state of the first electronic switch 22. The first electronic switch 22 is configured to control the first lamp bead 16, the second lamp bead 17, the third lamp bead 18, and the fourth lamp bead 19 to emit light according to different states.

When the first electronic switch 22 is in a first state, the first lamp bead 16 is turned on and emits light.

When the first electronic switch 22 is in a second state, the first lamp bead 16 and the second lamp bead 17 are turned on and emit light.

When the first electronic switch 22 is in a third state, the second lamp bead 17 is turned on and emits light.

When the first electronic switch 22 is in a fourth state, the first lamp bead 16, the second lamp bead 17, the third lamp bead 18 and the fourth lamp bead 19 are turned on and emit light.

When the first electronic switch 22 is in a fifth state, the third lamp bead 18 is turned on and emits light.

When the first electronic switch 22 is in a sixth state, the third lamp bead 18 and the fourth lamp bead 19 are turned on and emit light.

When the first electronic switch 22 is in a seventh state, the fourth lamp bead 19 is turned on and emits light.

The control device 10 further includes a cover box 38. The first toggle 23 of the angle controller 20 can extend out of the cover box 38 and the base 3, which is more convenient for the operator to operate.

Referring to FIG. 1, FIG. 2 and FIG. 4 to FIG. 6, a surface of the lens plate 11 away from the first light emitting element 13 and the second light emitting element 15 is provided with a light diffusion rib 24. The lens plate 11 includes a first lens plate 25, a second lens plate 26, a third lens plate 27, and a fourth lens plate 28. A side edge of the first lens plate 25 and an side edge of the second lens plate 26 are connected to each other. The first lens plate 25 and the second lens plate 26 intersect each other and an angle therebetween is an obtuse angle.

A plurality of protruding diamond-shaped lens portions 29 are provided between the first lens plate 25 and the second lens plate 26 on a side away from the first light emitting element 13 and the second light emitting element 15. The third lens plate 27 and the fourth lens plate 28 are provided in parallel at both ends of the first lens plate 25 and the second lens plate 26. The first lens plate 25, the second lens plate 26, the third lens plate 27, and the fourth lens plate 28 enclose the convex lens plate 11.

The first lens plate 25, the second lens plate 26, the third lens plate 27, the fourth lens plate 28, and the plurality of diamond-shaped lens portions 29 are provided with a plurality of strip-shaped grooves 30 on a side adjacent to the first light emitting element 13 and the second light emitting element 15.

The first lens plate 25, the second lens plate 26, the third lens plate 27, and the fourth lens plate 28 are each in a straight plane shape. When the base 3 is mounted on a wall, an angle between the first LED lamp panel 8 and the first lens plate 25 is an acute angle, and an angle between the second LED lamp panel 9 and the second lens plate 26 is an acute angle, an angle between the first LED lamp panel 8 and the second LED lamp panel 9 is an obtuse angle, and the first LED lamp panel 8 and the second LED lamp panel 9 can cooperate with the first lens plate 25 and the second lens plate 26, respectively. Taking the paper direction of FIG. 2 as a reference, a right side is the front and a left side is the rear. A part of the light emitted by the first LED lamp panel 8 passes through the first lens plate 25 and is directed sideways and downwards, another part of the light emitted by the first LED lamp panel 8 passes through the second lens plate 26 and is directed sideways, and another part of the light emitted by the first LED lamp panel 8 can pass through the third lens 27 and the fourth lens 28 respectively and is directed left and right sideways. A part of the light emitted by the second LED lamp panel 9 passes through the second lens plate 26 and is directed sideways and downwards, another part of the light emitted by the second LED lamp panel 9 passes through the first lens plate 25 and is directed forward and sideways, and another part of the light emitted by the second LED lamp panel 9 passes through the third lens 27 and the fourth lens 28 respectively and is directed left and right sideways.

The first lens plate 25, the plurality of diamond-shaped lens portions 29, the second lens plate 26, the third lens plate 27, and the fourth lens plate 28 are integrally formed.

The control device 10 may further include a color temperature controller 31. The color temperature controller 31 includes a second electronic switch 32 and a second toggle 33. The second electronic switch 32 is fixed on the switch base 21. The second electronic switch 32 is electrically connected to the driving power supply 2, the first LED lamp panel 8, and the second LED lamp panel 9, respectively. The second electronic switch 32 has a plurality of states, and the second toggle 33 is connected to the second electronic switch 32 and is configured to be toggled to change the state of the second electronic switch 32. The second electronic switch 32 is configured to control a color temperature of the LED lamp according to different states of the second electronic switch 32.

The second toggle 33 of the color temperature controller 31 can extend out of the cover box 38 and the base 3, which is more convenient for the operator to operate.

For example, when the first electronic switch 22 is in the first state, the first lamp bead 16 is turned on and emits light, the second electronic switch 32 is in a first state, and the color temperature value of the first lamp bead 16 is 3000K.

When the first electronic switch 22 is in the second state, the first lamp bead 16 and the second lamp bead 17 are turned on and emit light, the second electronic switch 32 is in a second state, and the color temperature value of the first lamp bead 16 and the second lamp bead 17 is 4000K.

When the first electronic switch 22 is in the third state, the second lamp bead 17 is turned on and emits light, the second electronic switch 32 is in a third state, and the color temperature value of the second lamp bead 17 is 5000K.

When the first electronic switch 22 is in the fourth state, the first lamp bead 16, the second lamp bead 17, the third lamp bead 18 and the fourth lamp bead 19 are turned on and emit light, the second electronic switch 32 is in a fourth state, and the color temperature value of the first lamp bead 16, the second lamp bead 17, the third lamp bead 18 and the fourth lamp bead 19 is 4000K.

When the first electronic switch 22 is in the fifth state, the third lamp bead 18 emits light, the second electronic switch 32 is in a fifth state, and the color temperature value of the third lamp bead 18 is 3000K.

When the first electronic switch 22 is in the sixth state, the third lamp bead 18 and the fourth lamp bead 19 are turned on and emit light, the second electronic switch 32 is in a sixth state, and the color temperature value of third lamp bead 18 and the fourth lamp bead 19 is 4000K.

When the second electronic switch 32 is in the seventh state, the fourth lamp bead 19 is turned on and emits light, the second electronic switch 32 is in a seventh state, and the color temperature value of the fourth lamp bead 19 is 5000K.

The LED lamp further includes a first sealing ring 34 provided between the lens plate 11 and the cover 4 and a second sealing ring 35 provided between the base 3 and the cover 4, so that a good waterproof effect can be achieved. The control device 10 further includes a plugging member 37, and the operator can adjust the angle or the color temperature by removing the plugging member 37, so as to achieve a good dustproof and waterproof effect.

Referring to FIG. 1 and FIG. 4, the LED lamp further includes a sensor 36 provided on the base 3. The sensor 36 is configured to sense external environmental parameters to control on and off of the LED lamp or brightness of the LED lamp.

According to the LED lamp, the first LED lamp panel 8 and/or the second LED lamp panel 9 can be flexibly turned on according to the lighting requirements of the application site, which can well meet the lighting requirements of full light cutoff and half light cutoff. The overall light is very soft without glare, and a good lighting effect can be achieved. In addition, whether the first light emitting element 13 and the second light emitting element 15 on the first LED lamp board 8 and the second LED lamp board 2 emit light can be switched, and the application sites are more extensive.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure.

1. An LED lamp, comprising:
a housing comprising a base and a cover covering the base, the cover being provided with a mounting groove, the cover comprising a first mounting surface and a second mounting surface, wherein a projection of the first mounting surface and a projection of the second mounting surface intersect with each other and are located within an interior of a mounting groove;
a first LED lamp panel provided on the first mounting surface;
a second LED lamp panel provided on the second mounting surface;
a driving power supply configured to supply power to the first LED lamp panel and the second LED lamp panel;
a control device electrically connected to the first LED lamp panel, the second LED lamp panel, and the driving power supply; and
a lens plate covering the first LED lamp panel and the second LED lamp panel in a light emitting direction,
wherein the first LED lamp panel comprises a first circuit board and a first light emitting element; the second LED lamp panel comprises a second circuit board and a second light emitting element, and the control device is configured to control light emitted from the first light emitting element and the second light emitting element as a function of their respective position along the lens plate;
wherein the lens plate is provided with a light diffusion rib, the lens plate comprises a first lens plate, a second lens plate, a third lens plate, and a fourth lens plate; the first lens plate is connected to the second lens plate, a plurality of diamond-shaped lens portions are provided between the first lens plate and the second lens plate on a side away from the first light emitting element and the second light emitting element, and the third lens plate and the fourth lens plate are provided in parallel at both ends of the first lens plate and the second lens plate.

2. (canceled)

3. The LED lamp according to claim 1, wherein the first lens plate, the second lens plate, the third lens plate, and the fourth lens plate are integrally formed and are each in a straight plane shape.

4. The LED lamp according to claim 3, wherein the first lens plate, the second lens plate, the third lens plate, and the fourth lens plate are provided with a plurality of strip-shaped grooves on a side adjacent to the first light emitting element and the second light emitting element.

5. The LED lamp according to claim 1, wherein the first light emitting element comprises a first lamp bead and a second lamp bead, and the second light emitting element comprises a third lamp bead and a fourth lamp bead.

6. The LED lamp according to claim 5, further comprising a cover box formed on the base; wherein the control device comprises an angle controller, the angle controller extending out of the cover box and the base; wherein the angle controller comprises a switch base, a first electronic switch, and a first toggle; wherein the switch base is fixed on the base and the first electronic switch is fixed on the switch base; wherein the first electronic switch comprises a plurality of states and is electrically connected to the driving power supply, the first LED lamp panel and the second LED lamp panel, respectively in series; wherein the first toggle is connected to the first electronic switch and is configured to be toggled to change a state of the first electronic switch, and the first electronic switch is configured to control the first lamp bead, the second lamp bead, the third lamp bead and the fourth lamp bead to emit light according to different states.

7. The LED lamp according to claim 6, wherein
when the first electronic switch is in a first state, the first lamp bead emits light;
when the first electronic switch is in a second state, the first lamp bead and the second lamp bead emit light;
when the first electronic switch is in a third state, the second lamp bead emits light;
when the first electronic switch is in a fourth state, the first lamp bead, the second lamp bead, the third lamp bead and the fourth lamp bead emit light;
when the first electronic switch is in a fifth state, the third lamp bead emits light;
when the first electronic switch is in a sixth state, the third lamp bead and the fourth lamp bead emit light;
when the first electronic switch is in a seventh state, the fourth lamp bead emits light.

8. The LED lamp according to claim 6, wherein the control device comprises a color temperature controller, the color temperature controller comprises a second electronic switch and a second toggle, and the second electronic switch is fixed on the switch base; wherein the second electronic switch further comprises a plurality of states and is electrically connected to the driving power supply, the first LED lamp panel, and the second LED lamp panel, respectively; wherein the second toggle is connected to the second electronic switch and is configured to be toggled to change a state of the second electronic switch, and the second electronic switch is configured to control a color temperature of the LED lamp accord to different states of the second electronic switch.

9. The LED lamp according to claim 1, further comprising a first sealing ring provided between the lens plate and the cover and a second sealing ring provided between the base and the cover.

10. The LED lamp according to claim 1, further comprising a sensor provided on the base, wherein the sensor is configured to sense external environmental parameters to control on and off of the LED lamp or brightness of the LED lamp.
